(19) United States
(12) Patent Application Publication
(10) Pub. No.: US 2021/0193995 A1
(43) Pub. Date: Jun. 24, 2021

(54) NEGATIVE ELECTRODE FOR NON-AQUEOUS ELECTROLYTE SECONDARY BATTERY, AND NON-AQUEOUS ELECTROLYTE SECONDARY BATTERY

(71) Applicants: Panasonic Corporation, Osaka (JP); Toyota Jidosha Kabushiki Kaisha, Toyota-shi (JP)

(72) Inventors: Naoto Onodera, Hyogo (JP); Katsunori Yanagida, Hyogo (JP); Yo Kato, Nagoya-shi (JP)

(73) Assignees: Panasonic Corporation, Osaka (JP); Toyota Jidosha Kabushiki Kaisha, Toyota-shi (JP)

(21) Appl. No.: 17/124,000

(22) Filed: Dec. 16, 2020

(30) Foreign Application Priority Data
Dec. 23, 2019 (JP) 2019-231498

(51) Int. Cl. H01M 4/36; H01M 10/0525; H01M 4/133; H01M 4/587; H01M 4/62

(52) U.S. Cl. CPC H01M 4/366; H01M 10/0525; H01M 4/133; H01M 2004/027; H01M 4/587; H01M 4/62; H01M 4/364

(57) ABSTRACT

This negative electrode comprises a electrode current collector, a first electrode mixture layer provided on the surface of the electrode current collector, and a second electrode mixture layer provided on the surface of the first electrode mixture layer. The first electrode mixture layer and the second electrode mixture layer have different volume change ratio upon charge and discharge. The first electrode mixture layer has an interface portion in contact with the second electrode mixture layer, and a body portion located nearer to the electrode current collector side than the interface portion. The thickness of the interface portion t satisfies a relationship t≤dg/2 with an average particle size of the graphite particles included in the first electrode mixture layer being dg. The content of an inorganic filler in the interface portion is higher than the content of the inorganic filler included in the body portion.

### CROSS REFERENCE TO RELATED APPLICATION

The entire disclosure of Japanese Patent Application No. 2019-231498 filed on Dec. 23, 2019, including the specification, claims, drawings, and abstract is incorporated herein by reference in its entirety.

### TECHNICAL FIELD

The present disclosure relates to a negative electrode for a non-aqueous electrolyte secondary battery, and a non-aqueous electrolyte secondary battery.

### BACKGROUND

With respect to negative electrode active materials, Sn, Si, and oxides thereof, have attracted attention recently as high energy density materials. Patent Literature 1 discloses a negative electrode in which, in order to make the capacity larger and suppress an internal short circuit of a secondary battery, a compound layer including Sn, Si or an oxide thereof is provided on a negative electrode current collector, and a carbon material layer including graphite is further provided on the compound layer.

However, when a negative electrode mixture layer has a two-layer structure, the upper layer and the lower layer each repeat expansion and contraction at a different volume change ratio due to repeated charge and discharge. Thus, in some cases, the upper layer and the lower layer are delaminated at the interface therebetween to thereby break the conductive path and result in deterioration in the battery capacity. Accordingly, the technique of Patent Literature 1 is still required to be improved in view of the improvement in the cycle characteristics.

### CITATION LIST

### Patent Literature

PATENT LITERATURE 1: Japanese Unexamined Patent Application Publication No. 2009-266705

### SUMMARY

### Technical Problem

Therefore, it is an advantage of the present disclosure to provide a negative electrode having a two-layer structure as well as having improved cycle characteristics.

### Solution to Problem

A negative electrode for a non-aqueous electrolyte secondary battery as one aspect of the present disclosure comprises a negative electrode current collector, a first negative electrode mixture layer including first graphite particles, the first negative electrode mixture layer being provided on the surface of the negative electrode current collector, and a second negative electrode mixture layer including second graphite particles, the second negative electrode mixture layer being provided on the surface of the first negative electrode mixture layer. The first negative electrode mixture layer and the second negative electrode mixture layer have different volume change ratio upon charge and discharge. The first negative electrode mixture layer has an interface portion in contact with the second negative electrode mixture layer, and a body portion located nearer to the negative electrode current collector side than the interface portion. The thickness of the interface portion t satisfies a relationship t≤dg/2 with an average particle size of the first graphite particles dg. The first negative electrode mixture layer includes an inorganic filler. The content of the inorganic filler in the interface portion is higher than the content of the inorganic filler included in the body portion.

A non-aqueous electrolyte secondary battery as one aspect of the present disclosure comprises the negative electrode for a non-aqueous electrolyte secondary battery described above, a positive electrode, and a non-aqueous electrolyte.

### Advantageous Effects of Invention

According to one aspect of the present disclosure, the deterioration in the battery capacity due to repeated charge and discharge may be suppressed.

### BRIEF DESCRIPTION OF DRAWINGS

Embodiment(s) of the present disclosure will be described based on the following figures, wherein:

FIG. 1 is a longitudinal sectional view of a cylindrical secondary battery of an exemplary embodiment; and

FIG. 2 is a sectional view of a negative electrode of an exemplary embodiment.

### DESCRIPTION OF EMBODIMENTS

As described above, in a secondary battery employing a negative electrode having a two-layer structure for a higher capacity, suppression of deterioration in the battery capacity due to repeated charge and discharge is difficult with the conventional techniques. The present inventors have therefore conducted intensive studies, and as a result, have found that providing an interface portion having a predetermined thickness and including an inorganic filler at a high density between two negative electrode mixture layers having different volume change ratio upon charge and discharge enables suppression of delamination between the upper layer and the lower layer at the interface therebetween, even when the negative electrode mixture layer repeats expansion and contraction upon charge and discharge. This is presumably because, when the inorganic filler is interposed between graphite particles included in the upper layer and graphite particles included in the lower layer, the inorganic filler functions as a wedge to suppress slipping of the graphite particles in the surface direction. Accordingly, the present inventors have conceived of a non-aqueous electrolyte secondary battery in which deterioration in the charge/discharge cycle characteristics is suppressed, shown in the following aspect.

A negative electrode for a non-aqueous electrolyte secondary battery as one aspect of the present disclosure comprises a negative electrode current collector, a first negative electrode mixture layer including first graphite particles, the first negative electrode mixture layer being provided on a surface of the negative electrode current collector, and a second negative electrode mixture layer including second graphite particles, the second negative electrode mixture layer being provided on the surface of the first negative electrode mixture layer. The first negative electrode mixture layer and the second negative electrode mixture layer have different volume change ratio upon charge and discharge. The first negative electrode mixture layer has an interface portion in contact with the second negative electrode mixture layer, and a body portion located nearer to the negative electrode current collector side than the interface portion. The thickness of the interface portion t satisfies a relationship t≤dg/2 with an average particle size of the first graphite particles dg. The first negative electrode mixture layer includes an inorganic filler. The content of the inorganic filler in the interface portion is higher than the content of the inorganic filler included in the body portion.

Hereinafter, an exemplary embodiment of a cylindrical secondary battery according to the present disclosure will be described in detail with reference to drawings. Specific shapes, materials, numeric values, directions, and the like in the description below are exemplary for the purpose of facilitating the understanding of the present invention, and may be appropriately changed in accordance with the specification of the cylindrical secondary battery. The exterior body is not limited to being cylindrical and may be rectangular or the like. In the following description, when a plurality of embodiments and modifications is included, use of characterizing portions thereof in an appropriate combination has been originally contemplated.

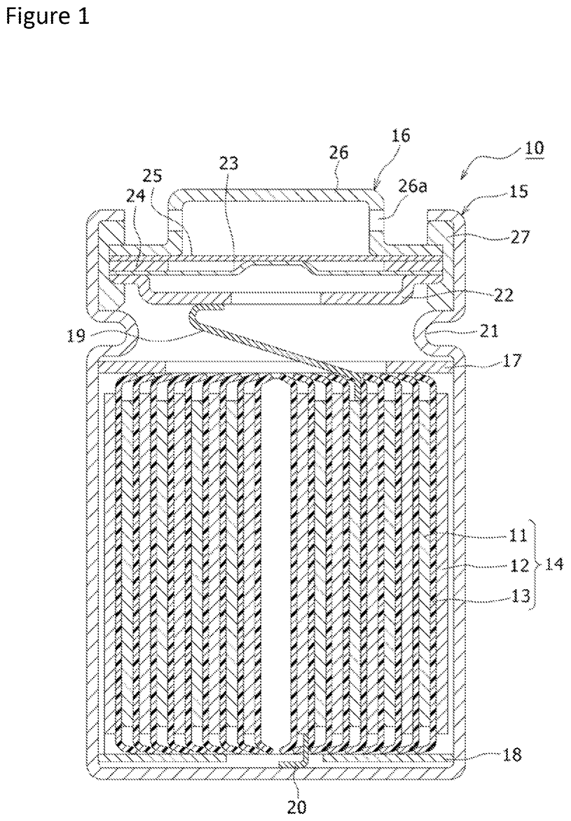

FIG. 1 is a longitudinal sectional view of a cylindrical secondary battery 10 of an exemplary embodiment. In the secondary battery 10 shown in FIG. 1, an electrode assembly 14 and a non-aqueous electrolyte (not shown) are housed in an exterior body 15. The electrode assembly 14 has a wound structure in which a positive electrode 11 and a negative electrode 12 are wound together with a separator 13 therebetween. In the description below, for convenience of description, the side of a sealing assembly 16 is defined as the “topside”, and the bottom side of the exterior body 15 is defined as the “underside”.

The opening end of the exterior body 15 is closed with the sealing assembly 16 to seal the interior of the secondary battery 10. Insulating plates 17 and 18 are each provided above and under the electrode assembly 14. A positive electrode lead 19 extends upward through a through-hole in the insulating plate 17 and is welded to the lower surface of a filter 22, which is the bottom plate of the sealing assembly 16. In the secondary battery 10, a cap 26, which is the top plate of the sealing assembly 16 electrically connected to the filter 22, serves as a positive electrode terminal. Meanwhile, a negative electrode lead 20 extends through a through-hole of the insulating plate 18 to the bottom side of the exterior body 15 and is welded on the inner surface of the bottom of the exterior body 15. In the secondary battery 10, the exterior body 15 serves as a negative electrode terminal. When the negative electrode lead 20 is disposed at a terminal end, the negative electrode lead 20 passes on the outside of the insulating plate 18, extends toward the bottom of the exterior body 15, and is welded on the inner surface of the bottom of the exterior body 15.

The exterior body 15 is, for example, a bottomed cylindrical metal exterior can. A gasket 27 is provided between the exterior body 15 and the sealing assembly 16 to ensure that the interior of the secondary battery 10 is tightly sealed. The exterior body 15 has a grooved portion 21 to support the sealing assembly 16, the grooved portion being formed by externally pressing the portion of the side wall, for example. The grooved portion 21 is preferably annularly formed along the peripheral direction of the exterior body 15, supporting the sealing assembly 16 with the upper surface thereof via the gasket 27.

The sealing assembly 16 has a filter 22, a lower vent member 23, an insulating member 24, an upper vent member 25, and a cap 26, stacked in the listed order sequentially from the side of the electrode assembly 14. Each of the members constituting the sealing assembly 16 has, for example, a disk or ring shape, and the members other than the insulating member 24 are electrically connected to each other. The lower vent member 23 and the upper vent member 25 are connected to each other at respective middle portions and the insulating member 24 is interposed between respective circumferences. When the internal pressure of the battery rises due to abnormal heat generation, the lower vent member 23, for example, ruptures to thereby cause the upper vent member 25 to bulge toward the side of the cap 26 and leave the lower vent member 23. Thus, the electrical connection therebetween is interrupted. If the internal pressure further increases, the upper vent member 25 ruptures to discharge gas through an opening 26a of the cap 26.

Hereinbelow, the positive electrode 11, the negative electrode 12, the separator 13, and the non-aqueous electrolyte constituting the secondary battery 10, particularly, a negative electrode mixture layer constituting the negative electrode 12, will be described in detail.

[Negative Electrode]

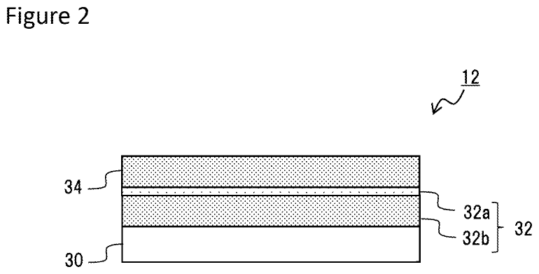

FIG. 2 is a sectional view of a negative electrode 12 of an exemplary embodiment. The negative electrode 12 comprises a negative electrode current collector 30, a first negative electrode mixture layer 32 provided on a surface of the negative electrode current collector 30, and a second negative electrode mixture layer 34 provided on the first negative electrode mixture layer 32. The thicknesses of the first negative electrode mixture layer 32 and the second negative electrode mixture layer 34 may be the same or different from each other. The thickness ratio between the first negative electrode mixture layer 32 and the second negative electrode mixture layer 34 is, for example, 3:7 to 7:3, preferably 4:6 to 6:4.

The negative electrode current collector 30 used here is, for example, foil of a metal, such as copper, which is stable in the electric potential range of the negative electrode, or a film in which such a metal is disposed on an outer layer. The thickness of the negative electrode current collector 30 is 5 μm to 30 μm, for example.

The first negative electrode mixture layer 32 includes first graphite particles, and the second negative electrode mixture layer 34 includes second graphite particles. In other words, the first negative electrode mixture layer 32 includes at least the first graphite particles as a negative electrode active material, and the second negative electrode mixture layer 34 includes at least the second graphite particles as a negative electrode active material. Examples of the first graphite particles and the second graphite particles can include natural graphite and artificial graphite. The average particle size of the first graphite particles and the second graphite particles (median diameter D50 by volume, the same applies hereinbelow) is preferably 5 μm to 30 μm, more preferably 8 μm to 20 μm. Each plane spacing (d₀₀₂) of the (002) plane with respect to the first graphite particles and the second graphite particles, according to a wide-angle X-ray diffraction method, is, for example, preferably 0.3354 nm or more, more preferably 0.3357 nm or more, and preferably less than 0.340 nm, more preferably 0.338 nm or less. Each crystallite size (Lc(002)) with respect to the first graphite particles and the second graphite particles, as determined according to an X-ray diffraction method, is, for example, preferably 5 nm or more, more preferably 10 nm or more, and preferably 300 nm or less, more preferably 200 nm or less. When the plane spacing (d₀₀₂) and the crystallite size (Lc(002)) satisfy the above respective ranges, the battery capacity of the secondary battery 10 tends to increase compared with the case where the above respective ranges are not satisfied.

Examples of the negative electrode active material included in the first negative electrode mixture layer 32 and the second negative electrode mixture layer 34 include a metal to be alloyed with lithium, such as Si or Sn, or a material reversibly occluding and releasing lithium ions, such as an alloy or oxide including a metal element such as Si or Sn, in addition to the graphite particles described above. In either the first negative electrode mixture layer 32 or the second negative electrode mixture layer 34, the content of the graphite particles can be, for example, 90 mass % to 100 mass % based on the total amount of the negative electrode active materials.

The first negative electrode mixture layer 32 and the second negative electrode mixture layer 34 may each further include a binder, a thickener, and the like. Examples of the binder include fluoro resins, PAN, polyimide resins, acrylic resins, polyolefin resins, styrene-butadiene rubber (SBR), and nitrile-butadiene rubber (NBR). Examples of the thickener include carboxymethyl cellulose (CMC) or salts thereof, poly(acrylic acid) (PAA) or salts thereof (PAA-Na, PAA-K, and the like which may be partially neutralized salts), and poly(vinyl alcohol) (PVA). These may be used singly or may be used in combinations of two or more thereof.

The first negative electrode mixture layer 32 and the second negative electrode mixture layer 34 have different volume change ratio upon charge and discharge (during charge and discharge). The volume change ratio of the first negative electrode mixture layer 32 may be larger or smaller than the volume change ratio of the second negative electrode mixture layer 34. In either case, upon charge and discharge, stress is applied to the interface between the first negative electrode mixture layer 32 and the second negative electrode mixture layer 34, and thus, delamination is likely to occur. For example, when at least either one of the first negative electrode mixture layer 32 and the second negative electrode mixture layer 34 includes a Si material, and the first negative electrode mixture layer 32 and the second negative electrode mixture layer 34 have a different content of the Si material, the first negative electrode mixture layer 32 and the second negative electrode mixture layer 34 have different volume change ratio. The Si material, a material that can reversibly occlude and release lithium ions, functions as a negative electrode active material. Examples of the Si material include Si, an alloy including Si, and silicon oxide such as SiOₓ (x is 0.8 to 1.6). The Si material is a negative electrode material that can enhance battery capacity more than graphite particles. The content of the Si material is, for example, preferably 1 mass % to 10 mass %, more preferably 3 mass % to 7 mass %, based on the total amount of the negative electrode active materials in view of, for example, an enhancement in battery capacity and suppression of deterioration in the rapid charge cycle characteristics. As another example, when the first graphite particles and the second graphite particles have different degrees of graphitization, the first negative electrode mixture layer 32 and the second negative electrode mixture layer 34 have different volume change ratio. Examples of a material having a high degree of graphitization can include natural graphite. In contrast, examples of a material having a low degree of graphitization can include artificial graphite such as hard carbon. The first negative electrode mixture layer 32 and the second negative electrode mixture layer 34 may each include one, or two or more, negative electrode active materials. There is no particular limitation on the combination of the materials as long as the layers have different volume change ratio upon charge and discharge.

Artificial graphite may be produced as follows, for example. Coke (precursor) serving as a main raw material is pulverized to a predetermined size, aggregated with an aggregating agent, and then pressure-molded into a block. The block is further graphitized by firing at a temperature of 2600° C. or more. The block molded body graphitized is pulverized and sieved to obtain graphite particles of a desired size. The internal porosity of the graphite particles can be adjusted here by the particle size of the precursor pulverized, the particle size of the precursor aggregated, and the like. The average particle size of the precursor pulverized is preferably, for example, in the range of 12 μm to 20 μm. The internal porosity of the graphite particles can also be adjusted by the amount of a volatile component added to the block molded product. When a portion of the aggregating agent added to the coke (precursor) volatilizes in firing, the aggregating agent can be used as a volatile component. Examples of such an aggregating agent include pitch.

As shown in FIG. 2, the first negative electrode mixture layer 32 has an interface portion 32a in contact with the second negative electrode mixture layer 34, and a body portion 32b located nearer to the negative electrode current collector 30 than the interface portion 32a. The thickness of the interface portion 32a, t, satisfies a relationship t≤dg/2 with the average particle size of the first graphite particles dg. The first negative electrode mixture layer 32 includes an inorganic filler, and the content of the inorganic filler in the interface portion 32a is higher than the content of the inorganic filler in the body portion 32b. Thus, the inorganic filler fixes the first graphite particles and the second graphite particles to thereby enable suppression of delamination between the first negative electrode mixture layer 32 and the second negative electrode mixture layer 34 at the interface. The content of the inorganic filler in the interface portion 32a is 1 mass % to 10 mass %, for example, and the content of the inorganic filler in the body portion 32b is 0 mass % to 5 mass %, for example. When the thickness of the interface portion 32a, t, exceeds dg/2, the electrical conduction between the first negative electrode mixture layer 32 and the second negative electrode mixture layer 34 is hindered. Then, the battery resistance of the secondary battery 10 increases, and the output of the secondary battery is lowered. The lower limit of t can be dg/10, for example. The thickness of the interface portion 32a, t, can be measured by observing a cross section of the negative electrode with a scanning electron microscope (SEM). When the thickness of the interface portion 32a is not uniform, measurements are taken at 10 points, and the average values of the points can be used as t.

The inorganic filler may be ceramic particles. Examples of the ceramic particles can include alumina, boehmite, and silica. The average particle size of the ceramic particles dc preferably satisfies a relationship of dc≤dg/10 with the average particle size of the first graphite particles being dg. This can increase the bonding force between the first negative electrode mixture layer 32 and the second negative electrode mixture layer 34 to thereby more securely suppress occurrence of delamination. The average particle size of the ceramic particles dc is preferably dc≥dg/30. When dc is less than dg/30, the bonding force for fixing the first graphite particles and the second graphite particles becomes smaller, and the delamination between the first negative electrode mixture layer 32 and the second negative electrode mixture layer 34 cannot be suppressed. The average particle size of ceramic particles dc is preferably 0.5 μm to 3 μm, more preferably 0.8 μm to 2 μm.

The content of the inorganic filler in the interface portion 32a can be 1 mass % to 10 mass % based on the content of the first graphite particles in the first negative electrode mixture layer 32. When the content of the inorganic filler is less than 1 mass %, sufficient binding force cannot be obtained. When the content exceeds 10 mass %, the battery resistance increases, and the output of the secondary battery is lowered.

Next, an exemplary specific method for forming the first negative electrode mixture layer 32 and the second negative electrode mixture layer 34 will be described. For example, first, a negative electrode active material including first graphite particles and SiOₓ (x is 0.8 to 1.6), a thickener, a binder, and a solvent such as water are mixed, then, an inorganic filler is added thereto, and the mixture is stirred such that the inorganic filler is not dispersed, to prepare a first negative electrode mixture slurry. Separately to this, a negative electrode active material including second graphite particles, a thickener, a binder, and a solvent such as water are mixed to prepare a second negative electrode mixture slurry. Then, both sides of the negative electrode current collector are coated with the first negative electrode mixture slurry, the resultant coatings are dried, thereafter, both sides of the coating of the first negative electrode mixture slurry are coated with the second negative electrode mixture slurry, and the resultant coatings are dried. Further, the first negative electrode mixture layer 32 and the second negative electrode mixture layer 34 can be rolled by a roller to thereby produce a negative electrode. As described above, when the inorganic filler is caused to be sufficiently dispersed in the first negative electrode mixture slurry, the inorganic filler migrates to the vicinity of the surface upon coating the negative electrode current collector 30 with the first negative electrode mixture slurry. Then, a body portion 32b and an interface portion 32a having a higher content concentration of the inorganic filler included than that of the body portion 32b are formed in the first negative electrode mixture layer 32. The above method, while involving coating with the second negative electrode mixture slurry after coating with the first negative electrode mixture slurry and drying, may be a method involving coating with the second negative electrode mixture slurry after coating with the first negative electrode mixture slurry and before drying. Alternatively, after coating with the first negative electrode mixture slurry, drying, and rolling the coatings, the first negative electrode mixture layer 32 may be coated with the second negative electrode mixture slurry.

[Positive Electrode]

The positive electrode 11 is configured from, for example, a positive electrode current collector of metal foil or the like, and a positive electrode mixture layer formed on the positive electrode current collector. Foil of a metal that is stable in the electric potential range of the positive electrode, such as aluminum, a film with such a metal disposed on an outer layer, and the like can be used for the positive electrode current collector. The positive electrode mixture layer includes, for example, a positive electrode active material, a binder, and a conductive agent.

The positive electrode 11 can be produced by, for example, coating the positive electrode current collector with a positive electrode mixture slurry including, for example, a positive electrode active material, a binder, and a conductive agent, drying the resultant to thereby form the positive electrode mixture layer, and then rolling this positive electrode mixture layer.

Examples of the positive electrode active material can include a lithium/transition metal oxide containing a transition metal element such as Co, Mn, or Ni. The lithium transition metal oxide is, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}MyO_{z}, LiₓMn₂O₄, LiₓMn_{2-y}MyO₄, LiMPO₄, or Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3). These may be used singly, or a plurality thereof may be mixed and used. The positive electrode active material preferably includes a lithium/nickel complex oxide such as LiₓNiO₂, LiₓCo_{y}Ni_{1-y}O₂, LiₓNi_{1-y}M_{y}O_{z} (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3) from the viewpoint that the capacity of the non-aqueous electrolyte secondary battery can be increased.

Examples of the conductive agent include carbon particles such as carbon black (CB), acetylene black (AB), Ketjenblack, and graphite. These may be used singly, or may be used in combinations of two or more thereof.

Examples of the binder include fluoro resins such as polytetrafluoroethylene (PTFE) and poly(vinylidene fluoride) (PVdF), polyacrylonitrile (PAN), polyimide resins, acrylic resins, and polyolefin resins. These may be used singly, or may be used in combinations of two or more thereof.

[Separator]

For example, an ion-permeable and insulating porous sheet is used as the separator 13. Specific examples of the porous sheet include a microporous thin film, woven fabric, and nonwoven fabric. Suitable examples of the material for the separator include olefin resins such as polyethylene (PE) and polypropylene (PP), and cellulose. The separator 13 may be a laminate including a cellulose fiber layer and a layer of fibers of a thermoplastic resin such as an olefin resin. The separator may be a multi-layered separator including a polyethylene layer and a polypropylene layer, and a surface of the separator 13 to be used may be coated with a material such as an aramid resin or ceramic.

[Non-Aqueous Electrolyte]

The non-aqueous electrolyte includes a non-aqueous solvent and an electrolyte salt dissolved in the non-aqueous solvent. The non-aqueous electrolyte is not limited to a liquid electrolyte (electrolyte solution), and may be a solid electrolyte using a gel polymer or the like. Examples of the non-aqueous solvent that can be used include esters, ethers, nitriles such as acetonitrile, amides such as dimethylformamide, and any mixed solvent of two or more thereof. The non-aqueous solvent may contain a halogen-substituted product formed by replacing at least a portion of hydrogen of any of the above solvents with a halogen atom such as fluorine.

Examples of the esters include cyclic carbonate esters such as ethylene carbonate (EC), propylene carbonate (PC), and butylene carbonate, chain carbonate esters such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylate esters such as γ-butyrolactone and γ-valerolactone, and chain carboxylate esters such as methyl acetate, ethyl acetate, propyl acetate, methyl propionate (MP), ethyl propionate, and γ-butyrolactone.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers; and chain ethers such as, 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Preferable examples of the halogen-substituted product for use include a fluorinated cyclic carbonate ester such as fluoroethylene carbonate (FEC), a fluorinated chain carbonate ester, and a fluorinated chain carboxylate ester such as methyl fluoropropionate (FMP).

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CnF₂ₙ₊₁)ₓ (where 1<x<6, and n is 1 or 2), LiB₁₀Cl₁₀, LiCl, LiBr, LiI, chloroborane lithium, lithium lower aliphatic carboxylate, borate salts such as Li₂B₄O₇ and Li(B(C₂O₄)F₂), and imide salts such as LiN(SO₂CF₃)₂ and LiN(C₁F₂ₗ₊₁SO₂)(CₘF₂ₘ₊₁SO₂) (where l and m are integers of 1 or more). These lithium salts may be used singly or a plurality thereof may be mixed and used. Among these, LiPF₆ is preferably used in view of ionic conductivity, electrochemical stability, and other properties. The concentration of the lithium salt is preferably 0.8 to 1.8 mol per liter of the solvent.

### EXAMPLES

Hereinafter, the present disclosure will be further described with reference to Examples, but the present disclosure is not intended to be limited to such Examples.

### Example 1

[Production of Positive Electrode]

A lithium/nickel/cobalt/manganese composite oxide (LiNi_{0.88}Co_{0.09}Mn_{0.03}O₂) is used as a positive electrode active material. Mixed are 100 parts by mass of the positive electrode active material, 1 part by mass of acetylene black as a conductive agent, and 0.9 parts by mass of a poly(vinylidene fluoride) powder as a binder, and an appropriate amount of N-methyl-2-pyrrolidone (NMP) is further added thereto to prepare a positive electrode mixture slurry. Both sides of a positive electrode current collector made of aluminum foil (thickness 15 μm) are coated with the slurry by a doctor blade method, and the resultant coatings are dried and then rolled by a roller to thereby produce a positive electrode in which a positive electrode mixture layer is formed on both the sides of the positive electrode current collector.

[Production of Negative Electrode]

Identical natural graphite having an average particle size of 12 μm is used as first graphite particles and second graphite particles. Boehmite having an average particle size of 1 μm is used as an inorganic filler. Artificial graphite, SiO, carboxymethyl cellulose (CMC), and styrene-butadiene copolymer rubber (SBR) are mixed such that the mass ratio thereof is 95:5:1:1, and kneaded in water. To the mixture, 5 parts by mass of boehmite is added. The mixture is stirred to the extent that boehmite is not dispersed to thereby prepare a first negative electrode mixture slurry. Then, natural graphite, carboxymethyl cellulose (CMC), and styrene-butadiene copolymer rubber (SBR) are mixed such that the mass ratio thereof is 98:1:1, and the mixture is kneaded in water to thereby prepare a second negative electrode mixture slurry.

Both sides of a negative electrode current collector made of copper foil are coated with the first negative electrode mixture slurry by a doctor blade method, and the resulting coatings are dried to thereby form a first negative electrode mixture layer. Further, the first negative electrode mixture layer is coated with the above second negative electrode mixture slurry, and the resulting coatings are dried to thereby form a second negative electrode mixture layer. At this time, the coating mass ratio per unit area between the first negative electrode mixture slurry and the second negative electrode mixture slurry is 5:5. The first negative electrode mixture layer and the second negative electrode mixture layer are rolled by a roller to thereby produce a negative electrode. As a result of cross section observation with a SEM, the thickness of the interface portion is 3 μm.

[Preparation of Non-Aqueous Electrolyte]

Ethylene carbonate (EC), methyl ethyl carbonate (MEC), and dimethyl carbonate (DMC) are mixed at a volume ratio of 20:40:40. Lithium hexafluorophosphate (LiPF₆) is dissolved at a concentration of 1 mol/liter in the mixed solvent to thereby prepare a non-aqueous electrolyte.

[Production of Test Cell]

An aluminum lead is attached to the above positive electrode, a nickel lead is attached to the above negative electrode, and the positive electrode and the negative electrode are laminated with a PP/PE/PP three-layer separator therebetween to produce a laminate electrode assembly. This electrode assembly is housed in an exterior body made of an aluminum-laminated sheet, the non-aqueous electrolyte is injected thereto, and then, the opening of the exterior body is sealed to thereby obtain a test cell.

[Evaluation of Battery Resistance]

The above test cell is charged at a constant current of 0.3 C under an environment at 25° C. until the state of charge (SOC) reaches 50%. After the SOC reached 50%, charging at a constant voltage is carried out until the current value reaches 0.02 C. Then, after storage under an environment at 25° C. for an hour, discharging at a constant current of 1 C is carried out for 10 seconds. The direct current resistance is calculated by dividing the difference between the open circuit voltage (OCV) and the closed circuit voltage (CCV) 10 seconds after discharging by the discharge current 10 second after discharging, as in the following expression.

Direct current resistance=[OCV−CCV (10 seconds after discharging)]/Discharge current (10 seconds after discharging)

[Measurement of Capacity Retention]

Each of the non-aqueous electrolyte secondary batteries of the Examples and Comparative Examples are charged to 4.2 V at a constant current of 0.5 C and then charged to 0.02 C at a constant voltage of 4.2 V at an environmental temperature of 25° C. Thereafter, each such battery is discharged to 2.5 V at a constant current of 0.5 C. Such charge and discharge are defined as one cycle, and performed for 200 cycles. The capacity retention in the charge/discharge cycle is determined according to the following expression.

Capacity retention=(Discharge capacity at 200th cycle/Discharge capacity at first cycle)×100

### Example 2

Each test cell is produced and evaluated in the same manner as in Example 1 except that no SiO is added to the first negative electrode mixture slurry and SiO is added to the second negative electrode mixture slurry such that graphite:SiO is 98:5.

### Comparative Example 1

Each test cell is produced and evaluated in the same manner as in Example 1 except that no boehmite is added to the first negative electrode mixture slurry.

### Comparative Example 2

Each test cell is produced and evaluated in the same manner as in Example 1 except that no boehmite is added to the first negative electrode mixture slurry and that natural graphite, boehmite, CMC, and SBR are mixed and kneaded in water to disperse boehmite to thereby prepare the second negative electrode mixture slurry.

### Comparative Example 3

Each test cell is produced and evaluated in the same manner as in Example 1 except that natural graphite, SiO, boehmite, CMC, and SBR are kneaded in water to disperse boehmite, to thereby prepare the first negative electrode mixture slurry.

### Comparative Example 4

Each test cell is produced and evaluated in the same manner as in Example 1 except that the first negative electrode mixture slurry and the second negative electrode mixture slurry prepared in Example 1 are mixed and a negative electrode current collector made of copper foil is coated with the mixed slurry as one layer.

The evaluation results of the test cells of Examples and Comparative Examples are summarized in Table 1. The compositions except for CMC and SBR (component and proportion) of the first negative electrode mixture layer and the second negative electrode mixture layer, and the thickness of the interface portion, are also shown in Table 1.

TABLE 1

| | Negative electrode | | | | |
|---|---|---|---|---|---|
| | First | Second | | Batt- | Ca- |
| | negative | negative | Interface | ery | pacity |
| | electrode | electrode | portion | resist- | reten- |
| | mixture | mixture | thickness | ance | tion |
| | layer | layer | (μm) | (mΩ) | (%) |
| Example 1 | Graphite/SiO/ | Graphite | 3 | 131 | 92 |
| | boehmite (95/5) | | | | |
| Example 2 | Graphite/ | Graphite/SiO | 3 | 127 | 90 |
| | boehmite (95/5) | (98/5) | | | |
| Comparative | Graphite/SiO | Graphite | — | 130 | 80 |
| Example 1 | (95/5) | | | | |
| Comparative | Graphite/SiO | Graphite/ | — | 127 | 83 |
| Example 2 | (95/5) | boehmite (95/5) | | | |
| | | *Boehmite | | | |
| | | dispersion state | | | |
| Comparative | Graphite/SiO/ | Graphite | — | 133 | 81 |
| Example 3 | boehmite | | | | |
| | (95/5/5) | | | | |
| | *Boehmite | | | | |
| | dispersion state | | | | |

| | | | | |
|---|---|---|---|---|
| Comparative | Graphite/SiO/boehmite | — | 129 | 77 |
| Example 4 | (95/5/5) | | | |

In Examples having the interface portion including boehmite, the charge/discharge cycle characteristics are improved. The battery resistance is confirmed to have no change even when the interface portion is formed.

### REFERENCE SIGNS LIST

10 secondary battery, 11 positive electrode, 12 negative electrode, 13 separator, 14 electrode assembly, 15 exterior body, 16 sealing assembly, 17, 18 insulating plate, 19 positive electrode lead, 20 negative electrode lead, 21 grooved portion, 22 filter, 23 lower vent member, 24 insulating member, 25 upper vent member, 26 cap, 26a opening, 27 gasket, 30 negative electrode current collector, 32 first negative electrode mixture layer, 32a interface portion, 34 second negative electrode mixture layer

1. A negative electrode for a non-aqueous electrolyte secondary battery, comprising:
a negative electrode current collector,
a first negative electrode mixture layer including first graphite particles, the first negative electrode mixture layer being provided on a surface of the negative electrode current collector, and
a second negative electrode mixture layer including second graphite particles, the second negative electrode mixture layer being provided on a surface of the first negative electrode mixture layer; wherein
the first negative electrode mixture layer and the second negative electrode mixture layer have different volume change ratio upon charge and discharge,
the first negative electrode mixture layer has an interface portion in contact with the second negative electrode mixture layer, and a body portion located nearer to the negative electrode current collector side than the interface portion,
a thickness of the interface portion t satisfies a relationship t≤dg/2 with an average particle size of the first graphite particles being dg,
the first negative electrode mixture layer includes an inorganic filler, and
a content of the inorganic filler in the interface portion is higher than a content of the inorganic filler included in the body portion.

2. The negative electrode for a non-aqueous electrolyte secondary battery according to claim 1, wherein
the inorganic filler is ceramic particles, and
an average particle size of the ceramic particles dc satisfies a relationship dc≤dg/10 with the average particle size of the first graphite particles being dg.

3. The negative electrode for a non-aqueous electrolyte secondary battery according to claim 1, wherein
the content of the inorganic filler in the interface portion is 1 mass % to 10 mass % based on a content of the first graphite particles in the first negative electrode mixture layer.

4. The negative electrode for a non-aqueous electrolyte secondary battery according to claim 1, wherein
at least either one of the first negative electrode mixture layer and the second negative electrode mixture layer includes a Si material, and
the first negative electrode mixture layer and the second negative electrode mixture layer have different content of the Si material.

5. The negative electrode for a non-aqueous electrolyte secondary battery according to claim 1, wherein
the first graphite particles and the second graphite particles have different degrees of graphitization.

6. A non-aqueous electrolyte secondary battery comprising:
the negative electrode for a non-aqueous electrolyte secondary battery according to claim 1;
a positive electrode; and
a non-aqueous electrolyte.
